(19) United States
(12) Patent Application Publication
(10) Pub. No.: US 2025/0101790 A1
(43) Pub. Date: Mar. 27, 2025

(54) OPENING DEVICE FOR A MOVABLE MOTOR-VEHICLE ELEMENT

(71) Applicant: KIEKERT AKTIENGESELLSCHAFT, Heiligenhaus (DE)

(72) Inventors: Uwe REDDMANN, Essen (DE); Benjamin DJEDOVIC, Oberhausen (DE)

(73) Assignee: KIEKERT AKTIENGESELLSCHAFT, Heiligenhaus (DE)

(21) Appl. No.: 18/727,811

(22) PCT Filed: Jan. 19, 2023
(86) PCT No.: PCT/DE2023/100040

§ 371 Date: Jul. 10, 2024

(30) Foreign Application Priority Data
Jan. 31, 2022 (DE) 10 2022 102 137.8

(51) Int. Cl. E05F 15/619

(52) U.S. Cl. CPC E05F 15/619; E05Y 2201/426; E05Y 2800/242; E05Y 2900/531

(57) ABSTRACT

An opening device is provided for a movable motor vehicle element, for example a motor vehicle door, a motor vehicle door handle, a motor vehicle fuel tank door, or the like. For this purpose, the opening device is equipped with an electric motor drive which has at least one electric motor and also has at least one transmission element rotationally driven by the at least one electric motor, said transmission element being provided for acting upon the movable motor vehicle element. According to the invention, the transmission element is rotationally acted upon by means of two or more electric motors jointly.

The invention relates to an opening device for a movable motor vehicle element, for example a motor vehicle door, a motor vehicle door handle, a motor vehicle fuel tank door, etc., with an electric motor drive which has at least one electric motor and also has at least one transmission element rotationally driven thereby for acting upon the movable motor vehicle element.

Opening devices for motor vehicle doors are typically used for reasons of convenience or when the motor vehicle door in question does not have an external door handle, for example for aerodynamic reasons. In order to enable and facilitate entry, for example after an electrically initiated unlocking and opening process of an associated door lock of the motor vehicle door in question, the motor vehicle door in question is opened or raised using the opening device, taking into account an opening gap. This allows the leaf of the motor vehicle door to be opened manually by an operator by reaching in and gripping behind the opening gap. In principle, for this purpose, and in addition, the opening device can be combined with an electric motor opening drive, which ensures that the vehicle door is fully opened after opening.

In addition, such opening devices can also be used to move a motor vehicle door handle from, for example, a recessed position to an exposed position. The recessed position is particularly aerodynamically advantageous. After unlocking the associated door lock, the relevant motor vehicle door handle can be extended using the opening device so that a user can then open the door lock or motor vehicle door lock and swing open the motor vehicle door.

Finally, such opening devices can be used, by way of example and not restrictively, to swing open a motor vehicle fuel tank door. Other movable motor vehicle elements, such as a glove compartment, a trunk lid, etc., can also be moved into an at least partially open position using such opening devices. Starting from this partially opened position, an operator or user is then able to fully open or swing open the relevant movable motor vehicle element.

In the generic state of the art according to DE 10 2017 223 104 A1, the electric motor there operates via an output shaft on a gear wheel as a rotationally driven transmission element. This ultimately works on the vehicle door via a gearbox or an actuating lever arrangement.

A similarly constructed and also generic opening device for a motor vehicle door element is described in DE 10 2018 132 665 A1. There, an actuating means acted upon by the drive and an additional gearbox arranged between the actuating means and the drive are implemented in order to make it possible to move a door element. The overall aim here is to enable safe opening even on sloping roads.

The prior art has proven itself in principle, but reaches its limits in cases where only a limited installation space is available. In fact, nowadays relatively large forces are often required, for example, to be able to open a motor vehicle door and in particular a motor vehicle side door and to define the required gap between a door leaf and an associated motor vehicle body. On the one hand, this can be attributed to the fact that vehicle doors and, in particular, vehicle side doors have increased significantly in weight due to the additional components installed in them over the years, such as side impact protection, airbags, loudspeakers, window lifters, etc. On the other hand, the motor vehicle doors in question are nowadays closed as tightly as possible in order to keep the interior noise-free or largely noise-free. This may also lead to increased forces during the opening process.

In practice, this has already been taken into account by the fact that the transmission element works on the movable motor vehicle element via an additional intermediately connected gearbox. As a result, however, the opening process is often delayed or is accomplished at a low speed, because the gearbox usually provides a large reduction ratio for the high-speed electric motor. Such a delayed opening is often found to be annoying by vehicle users. In order to achieve an acceleration here, it is therefore necessary to work with a powerful, voluminous electric motor, which however often cannot be installed due to the limited installation space available. The invention as a whole seeks to remedy this.

The invention is based on the technical problem of further developing such an opening device as a whole in such a way that a high drive power is provided, while at the same time having a compact design.

To solve this technical problem, a generic opening device for a movable motor vehicle element is characterized, within the scope of the invention, in that the transmission element is acted on rotationally using two or more electric motors jointly.

Here the invention is based first of all on the fundamental recognition that two or more electric motors, each of which is compact in size, are capable of delivering power comparable to that of one larger electric motor. At the same time, such compact electric motors, with the same total sum of power compared to a larger electric motor, have an overall smaller constructive volume (compared to the larger electric motor) and are also more flexible in terms of their arrangement relative to one another. That is, the available installation space, for example inside a motor vehicle door in the area of an axis of rotation of the motor vehicle door in question, can be optimally and flexibly utilized and filled at the same time.

At the same time, the transmission element in question is set into rotational movement by the two or more electric motors jointly. That is, the drive power provided by each individual electric motor adds up to a total drive power by which the common transmission element is driven rotationally. The transmission element can be followed by either a gearbox or a lever arrangement in order to ultimately ensure the desired opening process of the movable motor vehicle element.

In addition to the optimal installation space adaptation and compact design of the opening device according to the invention, a further advantage to be taken into account is that, typically, compact electric motors are, in total, more cost-effective than a larger electric motor with the same drive power, so that cost advantages are also observed for the opening device according to the invention. Finally, the multiple electric motors in conjunction with the common transmission element, as described, can also be flexibly adapted to the available installation space, so that the overall assembly of the opening device is also made easier. This is further contributed to by the fact that, for example, two electric motors with the same combined drive power generally have a lower total weight than a larger electric motor, which further facilitates installation. These are the main advantages.

According to a further advantageous embodiment, the transmission element is generally designed as a drive disk that can rotate about an axis. The drive disk can be equipped with a toothing on its outer circumference. Each electric motor generally has a drive worm on its output shaft.

In this way, each electric motor can engage, with its associated and respective drive worm, with the outer circumferential toothing of the drive disk to drive it rotationally. Furthermore, since the drive disk is equipped with the toothing on the outer circumference, the two or more electric motors can be flexibly placed on the outer circumference of the drive disk. The only thing that matters here is that in each case the drive worm of the associated electric motor is aligned tangentially to the outer circumferential toothing of the drive disk. This makes flexible arrangements of the electric motors conceivable, for example such that the output shafts of the electric motors in question form an angle to one another. This can be a right angle. It is also possible for multiple electric motors, in each case with their output shafts or the drive worms arranged on them, to rest at an acute angle on the outer circumferential toothing, similar to the blades of a radial fan.

Moreover, the invention favors two basic approaches. According to a first variant, the two electric motors can each act individually on the transmission element. In this case, it has proven to be effective if the two electric motors are parallel to each other and act on the transmission element located between them. However, it is also possible for the two electric motors (arranged parallel to each other) to be arranged opposite each other in relation to the transmission element arranged between them.

According to another, alternative variant, the two electric motors can be coupled to each other via a common output shaft and act on the transmission element. In this case, the procedure is usually such that the common output shaft has a common drive worm for engagement with the outer circumferential toothing of the drive disk. That is, in this case a quasi-continuous common output shaft of the two electric motors is realized. Here the two electric motors are located at each end of the output shaft between them. The output shaft is in turn equipped with a common (single) drive worm. The drive worm engages in the outer circumferential toothing of the drive disk, so that in this case as well the drive power of each of the electric motors is available cumulatively, i.e., the two drive powers of the electric motors are summed to drive the common transmission element, or the drive disk.

As a result, an opening device for a movable motor vehicle element is provided which can be easily installed even under tight installation conditions and taking into account a limited installation space. Nonetheless, a drive power is provided for the transmission element that corresponds to that of an electric motor that is larger in comparison. In this way, the transmission element can apply a significant force or a high torque to the movable motor vehicle element, optionally with the interposition of a gearbox and/or a lever arrangement, which force or torque provides a high opening speed. These are the main advantages.

The invention is explained in greater detail below with reference to drawings which show only one exemplary embodiment. In the drawings:

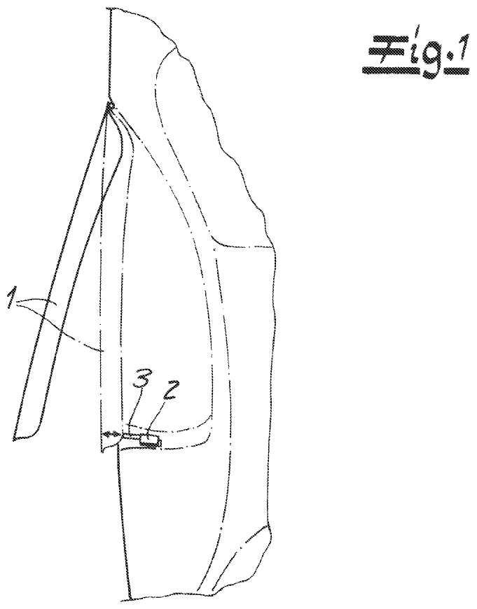

FIG. 1 shows the opening device according to the invention schematically in connection with a motor vehicle door and in particular a motor vehicle side door,

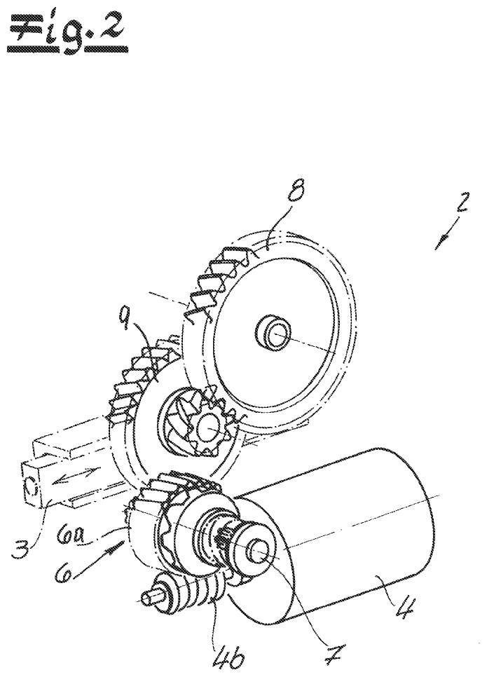

FIG. 2 shows the electric motor drive in a perspective view, and

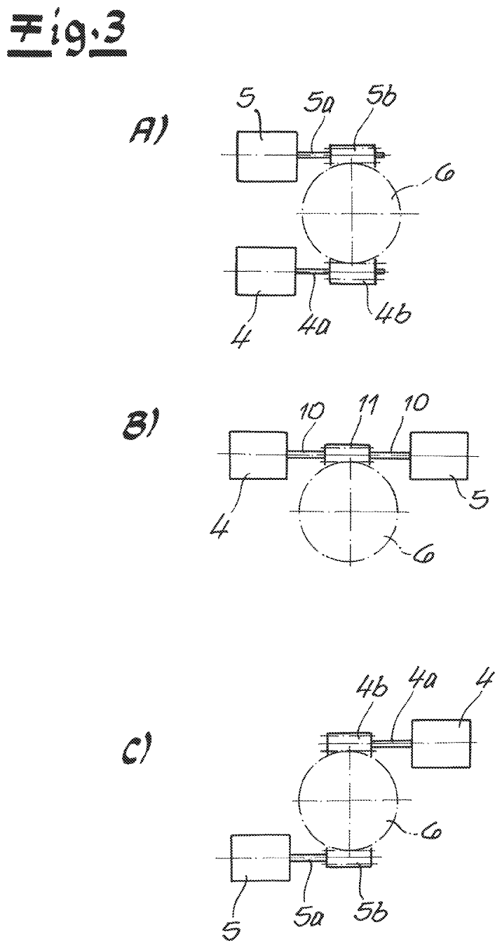

FIGS. 3A, 3B and 3C show different configurations of the electric motors.

The figures show an opening device for a movable motor vehicle element 1. According to the embodiment in FIG. 1, the movable motor vehicle element 1 is a motor vehicle door 1, which in the present case is a motor vehicle side door 1. In general, the opening device can however also be used in conjunction with a motor vehicle door handle or a motor vehicle fuel tank door, as explained in the introduction to the description. The motor vehicle door handle is an external door handle of the motor vehicle door 1.

For this purpose, the basic design of the opening device includes an electric motor drive 2, which operates on an actuating means or, according to the embodiment, a linear actuating slide 3. The actuating slide 3 can perform linear movements, indicated in FIG. 1 according to the double arrow shown there, in order in this way to open the motor vehicle door 1 at least as far as is indicated by the dash-dotted lines in FIG. 1. As a result, an opening gap is observed between a door leaf of the motor vehicle door 1 and a motor vehicle body, through which gap a user can grasp the door leaf of the motor vehicle door 1 in question and swing it open into the opening position shown in solid lines. In principle, this can also be done by motor.

FIG. 2 shows the detailed structure of the electric motor drive 2, which for this purpose is equipped with an electric motor 4 or, according to the embodiment, two electric motors 4, 5, namely a first electric motor 4 and a second electric motor 5. The electric motor 4, or both electric motors 4, 5, operate on a transmission element 6 driven thereby, which according to the embodiment is a drive disk 6 with a toothing 6a on its outer circumference, which toothing can only be seen in FIG. 2. The transmission element or the drive disk 6 is driven rotationally by means of the electric motor 4 or the two electric motors 4, 5; i.e., it is set into rotation about an axis 7.

In fact and according to the invention, the design is such that the transmission element 6 is acted on so as to rotate using the two or more electric motors 4, 5 jointly. That is, the two electric motors 4, 5 work cumulatively on the transmission element e with respect to the drive power they each provide; i.e., their drive power is added together. As a result, a significant torque is available at the transmission element or the drive disk 6, wherein the two electric motors 4, 5 operate flexibly while at the same time taking into account a reduced installation space on the transmission element 6 compared to the prior art, as will be explained in more detail below with reference to FIG. 3.

From FIG. 2 it can be seen that the transmission element 6 is followed by a downstream gearbox with gear wheels 8, 9, with the help of which the actuating slide 3 is acted upon so as to produce the required linear movements, as can be understood from FIG. 2. For this purpose, the gear wheels 8, 9 are in engagement with each other and also with an output-side toothing of the transmission element 6. Instead of the gear arrangement shown in FIG. 2, alternatively or additionally a lever arrangement can be used in order to ultimately be able to open the motor vehicle door 1 in the example case, which, however, is not shown.

Based on FIGS. 3A to 3C, different configurations of the two electric motors 4, 5 for the joint acting on the transmission element or the drive disk 6 can now be understood. In fact, each electric motor 4, 5 is first of all equipped for this purpose with an associated output shaft 4a, 5a and a drive worm 4b, 5b on the output shaft 4a, 5a. The output worm 4b, 5b engages here with the outer circumferential toothing 6a of the drive disk 6 to drive it rotationally about the axis 7.

As shown in FIGS. 3A and 3C, the two electric motors 4, 5 can each act individually on the transmission element or the drive disk 6. For this purpose, it is conceivable for the two electric motors 4, 5 to act parallel to each other on the transmission element or the drive disk 6 located between them, as is shown in the embodiment according to FIG. 3A. Alternatively, however, it is also possible to arrange the two electric motors 4, 5 opposite one another in relation to the transmission element or drive disk 6 located between them, as shown graphically in FIG. 3C. In this case as well, the electric motors 4, 5 are arranged parallel to each other.

In an alternative shown in FIG. 3B, it is also possible to couple the two electric motors 4, 5 to one another via a common output shaft 10. The two electric motors 4, 5 are then located at each end of the common output shaft 10. In addition, the common output shaft 10 is equipped with a common drive worm 11 which is configured and designed to engage with the outer circumferential toothing 6a of the drive disk 6, or generally of the transmission element 6. In this case as well, the electric motors 4, 5 act cumulatively on the transmission element or the drive disk 6. As a result, in all cases a drive power is available which corresponds to that of a much larger single electric motor 4.

### LIST OF REFERENCE SIGNS

Motor vehicle door 1
Motor vehicle side door 1
Drive 2
Actuating slide 3
Electric motor 4, 5
Output worm 4b, 5b
Drive disk 6
Transmission element 6
Toothing 6a
Axis 7
Gear wheels 8, 9
Output shaft 10

1. An opening device for a movable motor vehicle element, the opening device comprising:
an electric motor drive which has at least two electric motors and at least one transmission element rotationally driven by the at least two electric motors, the electric motor drive acting upon the movable motor vehicle element,
wherein the transmission element is rotationally acted upon jointly by two or more electric motors of the at least two electric motors.

2. The opening device according to claim 1, wherein the transmission element comprises a drive disk rotatable about an axis.

3. The opening device according to claim 2, wherein the drive disk is equipped with a toothing on an outer circumference of the drive disk.

4. The opening device according to claim 3, wherein each of the two electric motors has an output shaft and a drive worm on the output shaft.

5. The opening device according to claim 4, wherein each drive worm of the two electric motors engages in the outer circumferential toothing of the drive disk to drive the drive disk rotationally.

6. The opening device according to claim 1, wherein the two electric motors each act individually on the transmission element.

7. The opening device according to claim 6, wherein the transmission element is located between the two electric motors in parallel to one another, or the two electric motors are arranged opposite one another relative to the transmission element located between the two electric motors.

8. The opening device according to claim 1, wherein the two electric motors are coupled to one another via a common output shaft to act on the transmission element.

9. The opening device according to claim 8, wherein the common output shaft has a common drive worm for engaging in an outer circumferential toothing of the drive disk.

10. A motor vehicle door comprising the opening device according to claim 1 for opening the motor vehicle door, wherein the motor vehicle comprises a motor vehicle side door.

11. A motor vehicle door comprising the opening device according to claim 1 for opening the motor vehicle door, wherein the motor vehicle door includes an external door handle and the opening device acts on the external door handle.

12. The opening device according to claim 4, wherein the output shafts of the two electric motors are positioned at a non-straight angle relative to each other.

13. The opening device according to claim 4, wherein the output shafts of the two electric motors each are positioned at an acute angle relative to the toothing of the drive disk.

14. The opening device according to claim 8, wherein the output shafts of the two electric motors are positioned at opposite ends of the common output shaft.

15. The opening device according to claim 1, further comprising a downstream gear box that is acted upon by the transmission element, and a slider that is acted upon by the downstream gear box and that acts on the movable motor vehicle element.
